(19) United States
(12) Patent Application Publication
(10) Pub. No.: US 2026/0301669 A1
(43) Pub. Date: Oct. 1, 2026

(54) PIXEL CIRCUIT, DRIVING METHOD, AND DISPLAY DEVICE

(71) Applicants: Beijing BOE Technology Development Co., Ltd., Beijing (CN); BOE Technology Group Co., Ltd., Beijing (CN)

(72) Inventors: Lipeng Gao, Beijing (CN); Haoliang Zheng, Beijing (CN); Minghua Xuan, Beijing (CN); Yuzhen Guo, Beijing (CN); Jiao Zhao, Beijing (CN); Li Xiao, Beijing (CN); Chenyang Zhang, Beijing (CN); Xiaorong Cui, Beijing (CN)

(73) Assignees: Beijing BOE Technology Development Co., Ltd., Beijing (CN); BOE Technology Group Co., Ltd., Beijing (CN)

(21) Appl. No.: 18/996,624

(22) PCT Filed: Nov. 9, 2023
(86) PCT No.: PCT/CN2023/130640

§ 371 Date: Jan. 17, 2025

(51) Int. Cl. G09G 3/3233; G09G 3/32

(52) U.S. Cl. CPC G09G 3/3233; G09G 3/32; G09G 2300/043; G09G 2300/0819; G09G 2300/0852; G09G 2310/08; G09G 2320/0233; G09G 2320/045

(57) ABSTRACT

A pixel circuit, driving method, and display device are provided. The pixel circuit includes a light-emitting element, a first energy storage circuit, a second energy storage circuit, a third energy storage circuit, a driving circuit, a data writing circuit, a transfer control circuit, and a first setting circuit. The first energy storage circuit is electrically connected to a first node and a DC voltage terminal. The second energy storage circuit is electrically connected to a second node and a third node. The third energy storage circuit is electrically connected to a second terminal of the first energy storage circuit and the third node. The data writing circuit writes a data voltage to the first node under a control of a writing control signal. The transfer control circuit controls the connection between the first node and the second node under a control of a first scanning signal.

### TECHNICAL FIELD

The present disclosure relates to the field of display technologies, in particular to a pixel circuit, driving method, and display device.

### BACKGROUND

In related technologies, within an OLED (Organic Light Emitting Diode) panel, each sub-pixel includes a driving transistor. The current driving the organic light emitting diode is directly affected by the threshold voltage Vth of the driving transistor. However, there are variations in characteristics such as the threshold voltage and mobility of the driving transistors in different pixel circuits within the panel, which can result in different driving currents for different sub-pixels under the same data voltage signal, ultimately affecting the brightness uniformity of the panel. However, in traditional designs, the threshold voltage and the data voltage for controlling grayscale are written for a long time, or threshold voltage compensation and data voltage writing for controlling grayscale are performed simultaneously, resulting in high required light emitting brightness of the device or difficulty in ensuring sufficient compensation for the threshold voltage. Therefore, in order to ensure sufficient compensation for the threshold voltage and the ratio of the light emitting time to the frame time, it is necessary to reduce the light emitting brightness as much as possible and extend service life of the components.

### SUMMARY

In a first aspect, the embodiment of the present disclosure provides a pixel circuit, including a light-emitting element, a first energy storage circuit, a second energy storage circuit, a third energy storage circuit, a driving circuit, a data writing circuit, a transfer control circuit, and a first setting circuit;
the first energy storage circuit is electrically connected to a first node and a DC voltage terminal; the second energy storage circuit is electrically connected to a second node and a third node; the third energy storage circuit is electrically connected to a second terminal of the first energy storage circuit and the third node; the first energy storage circuit, the second energy storage circuit, and the third energy storage circuit are configured to store electrical energy;
a control terminal of the driving circuit is electrically connected to the second node, a first terminal of the driving circuit is electrically connected to the first voltage terminal, and a second terminal of the driving circuit is electrically connected to the light-emitting element through the third node, the driving circuit is configured to generate a driving current to drive the light-emitting element under a control of potential of the second node;
the data writing circuit is electrically connected to a writing control terminal, a data line, and the first node, and is configured to write a data voltage provided by the data line to the first node under a control of a writing control signal provided by the writing control terminal;
the transfer control circuit is electrically connected to a first scanning terminal, the first node, and the second node, and is configured to control the connection between the first node and the second node under a control of a first scanning signal provided by the first scanning terminal;
the first setting circuit is electrically connected to a second scanning terminal, the second node, and a setting voltage terminal, and is configured to write a setting voltage provided by the setting voltage terminal to the second node under a control of a second scanning signal provided by the second scanning terminal.

Optionally, the pixel circuit according to at least one embodiment of the present disclosure further includes a first light emitting control circuit;
the first light emitting control circuit is electrically connected to a first light emitting control terminal, the third node, and a first electrode of the light-emitting element, and is configured to control the connection between the third node and the first electrode of the light-emitting element under a control of a first light emitting control signal provided by the first light emitting control terminal;
a second electrode of the light-emitting element is electrically connected to the second voltage terminal.

Optionally, the pixel circuit according to at least one embodiment of the present disclosure further includes a second setting circuit;
the second setting circuit is electrically connected to a third scanning terminal and a third voltage terminal, the second setting circuit is further electrically connected to the second node or the third node, the second setting circuit is configured to write a third voltage signal provided by the third voltage terminal into the second node or the third node under a control of a third scanning signal provided by the third scanning terminal.

Optionally, the pixel circuit according to at least one embodiment of the present disclosure further includes a second light emitting control circuit; the first terminal of the driving circuit is electrically connected to the first voltage terminal through the second light emitting control circuit;
the second light emitting control circuit is electrically connected to a second light emitting control terminal, and is configured to control the connection between the first voltage terminal and the first terminal of the driving circuit under a control of a second light emitting control signal provided by the second light emitting control terminal.

Optionally, the first energy storage circuit includes a first capacitor, the second energy storage circuit includes a second capacitor, and the third energy storage circuit includes a third capacitor;
a first terminal of the first capacitor is electrically connected to the first node, and a second terminal of the first capacitor is electrically connected to the DC voltage terminal;
a first terminal of the second capacitor is electrically connected to the second node, and a second terminal of the second capacitor is electrically connected to the third node;
a first terminal of the third capacitor is electrically connected to the second terminal of the first capacitor, and a second terminal of the third capacitor is electrically connected to the third node.

Optionally, the data writing circuit includes a first transistor, and the transfer control circuit includes a second transistor;
a gate of the first transistor is electrically connected to the writing control terminal, a first electrode of the first transistor is electrically connected to the data line, and a second electrode of the first transistor is electrically connected to the first node;
a gate of the second transistor is electrically connected to the first scanning terminal, a first electrode of the second transistor is electrically connected to the first node, and a second electrode of the second transistor is electrically connected to the second node.

Optionally, the first setting circuit includes a third transistor;
a gate of the third transistor is electrically connected to the second scanning terminal, a first electrode of the third transistor is electrically connected to the setting voltage terminal, and a second electrode of the third transistor is electrically connected to the second node.

Optionally, the second setting circuit includes a fourth transistor;
a gate of the fourth transistor is electrically connected to the third scanning terminal, a first electrode of the fourth transistor is electrically connected to the third voltage terminal, and a second electrode of the fourth transistor is electrically connected to the second node or the third node.

Optionally, the driving circuit includes a driving transistor, the second light emitting control circuit includes a fifth transistor, and the first light emitting control circuit includes a sixth transistor;
a gate of the driving transistor is electrically connected to the second node, and a second electrode of the driving transistor is electrically connected to the third node;
a gate of the fifth transistor is electrically connected to the second light emitting control terminal, a first electrode of the fifth transistor is electrically connected to the first voltage terminal, and a second electrode of the fifth transistor is electrically connected to the first electrode of the driving transistor;
a gate of the sixth transistor is electrically connected to the first light emitting control terminal, a first electrode of the sixth transistor is electrically connected to the third node, and a second electrode of the sixth transistor is electrically connected to the first electrode of the light-emitting element.

In a second aspect, the embodiment of the present disclosure provides a driving method, applied to the above pixel circuit, a display period of the pixel circuit includes a compensation stage, a data transfer stage, and a light emitting stage set sequentially, the light emitting stage includes a data writing period; the driving method includes:
in the compensation stage, the first setting circuit writes the setting voltage provided by the setting voltage terminal to the second node under the control of the second scanning signal, the first voltage signal provided by the first voltage terminal charges each energy storage circuit through the driving circuit to change the potential of the third node until the driving circuit is disconnected;
in the data transfer stage, the transfer control circuit controls the connection between the first node and the second node under the control of the first scanning signal;
in the light emitting stage, the driving circuit drives the light-emitting element to emit light;
during the data writing period, the data writing circuit writes the data voltage provided by the data line to the first node under the control of the writing control signal.

Optionally, the pixel circuit further includes a first light emitting control circuit; the driving method further includes:
in the light emitting stage, the first light emitting control circuit controls the connection between the third node and the first electrode of the light-emitting element under the control of the first light emitting control signal.

Optionally, the pixel circuit further includes a second setting circuit; the display period further includes an initialization stage set before the compensation stage; the driving method further includes:
in the initialization stage, the second setting circuit writes the third voltage signal into the second node or the third node under the control of the third scanning signal.

Optionally, the pixel circuit further includes a second light emitting control circuit; the driving method further includes:
in the compensation stage and the light emitting stage, the second light emitting control circuit controls the connection between the first voltage terminal and the first terminal of the driving circuit under the control of the second light emitting control signal.

In a third aspect, the embodiment of the present disclosure provides a display device, including the above pixel circuit.

### BRIEF DESCRIPTION OF THE DRAWINGS

FIG. 1 is a structural schematic view of a pixel circuit according to at least one embodiment of the present disclosure;

FIG. 2 is a structural schematic view of a pixel circuit according to at least one embodiment of the present disclosure;

FIG. 3 is a structural schematic view of a pixel circuit according to at least one embodiment of the present disclosure;

FIG. 4 is a structural schematic view of a pixel circuit according to at least one embodiment of the present disclosure;

FIG. 5 is a structural schematic view of a pixel circuit according to at least one embodiment of the present disclosure;

FIG. 6 is a structural schematic view of a pixel circuit according to at least one embodiment of the present disclosure;

FIG. 7 is a structural schematic view of a pixel circuit according to at least one embodiment of the present disclosure;

FIG. 8 is an operational timing diagram of at least one embodiment of the pixel circuit shown in FIG. 7;

FIG. 9A is a schematic diagram of a working state of at least one embodiment of the pixel circuit shown in FIG. 7 in an initialization stage S1;

FIG. 9B is a schematic diagram of a working state of at least one embodiment of the pixel circuit shown in FIG. 7 in a compensation Stage S2;

FIG. 9C is a schematic diagram of a working state of at least one embodiment of the pixel circuit shown in FIG. 7 in a data transfer stage S3;

FIG. 9D is a schematic diagram of a working state of at least one embodiment of the pixel circuit shown in FIG. 7 during a data writing period S41;

FIG. 10 is a circuit diagram of the pixel circuit according to at least one embodiment of the present disclosure;

FIG. 11A is a schematic diagram of a working state of at least one embodiment of the pixel circuit shown in FIG. 10 in an initialization stage S1;

FIG. 11B is a schematic diagram of a working state of at least one embodiment of the pixel circuit shown in FIG. 10 in a compensation Stage S2;

FIG. 11C is a schematic diagram of a working state of at least one embodiment of the pixel circuit shown in FIG. 10 in a data transfer stage S3;

FIG. 11D is a schematic diagram of a working state of at least one embodiment of the pixel circuit shown in FIG. 10 during a data writing period S41;

FIG. 12 is a circuit diagram of the pixel circuit according to at least one embodiment of the present disclosure;

FIG. 13A is a schematic diagram of a working state of at least one embodiment of the pixel circuit shown in FIG. 12 in an initialization stage S1;

FIG. 13B is a schematic diagram of a working state of at least one embodiment of the pixel circuit shown in FIG. 12 in a compensation Stage S2;

FIG. 13C is a schematic diagram of a working state of at least one embodiment of the pixel circuit shown in FIG. 12 in a data transfer stage S3; and

FIG. 13D is a schematic diagram of a working state of at least one embodiment of the pixel circuit shown in FIG. 12 during a data writing period S41.

### DETAILED DESCRIPTION

The technical solutions in the embodiments of the present disclosure will be described clearly and completely below with reference to the drawings in the embodiments of the present disclosure, apparently, the described embodiments are part of the embodiments of the present disclosure, rather than all of embodiments. Based on the embodiments in the present disclosure, all other embodiments obtained by those ordinarily skilled in the art without paying creative efforts shall fall within the protection scope of the present disclosure.

The transistors used in all embodiments disclosed herein can be thin film transistors, field-effect transistors, or other elements with similar characteristics. In embodiments of the present disclosure, to distinguish between two electrodes of the transistor except for the gate, one electrode is referred to as the first electrode, and the other electrode is referred to as the second electrode.

In practical operation, when the transistor is a thin film transistor or a field-effect transistor, the first electrode may be a drain and the second electrode may be a source; Alternatively, the first electrode may be a source and the second electrode may be a drain.

The pixel circuit according to an embodiment of the present disclosure includes a light-emitting element, a first energy storage circuit, a second energy storage circuit, a third energy storage circuit, a driving circuit, a data writing circuit, a transfer control circuit, and a first setting circuit;

The first energy storage circuit is electrically connected to a first node and a DC voltage terminal; the second energy storage circuit is electrically connected to a second node and a third node; The third energy storage circuit is electrically connected to a second terminal of the first energy storage circuit and the third node; the first energy storage circuit, the second energy storage circuit, and the third energy storage circuit are configured to store electrical energy;

A control terminal of the driving circuit is electrically connected to the second node, a first terminal of the driving circuit is electrically connected to the first voltage terminal, and a second terminal of the driving circuit is electrically connected to the light-emitting element through the third node. The driving circuit is configured to generate a driving current to drive the light-emitting element under a control of potential of the second node;

The data writing circuit is electrically connected to a writing control terminal, a data line, and the first node, and is configured to write a data voltage provided by the data line to the first node under a control of a writing control signal provided by the writing control terminal;

The transfer control circuit is electrically connected to a first scanning terminal, the first node, and the second node, and is configured to control the connection between the first node and the second node under a control of a first scanning signal provided by the first scanning terminal;

The first setting circuit is electrically connected to a second scanning terminal, the second node, and a setting voltage terminal, is configured to write a setting voltage provided by the setting voltage terminal into the second node under a control of a second scanning signal provided by the second scanning terminal.

In related technologies, within an OLED (Organic Light Emitting Diode) panel, each sub-pixel includes a driving transistor. The current driving the organic light emitting diode is directly affected by the threshold voltage Vth of the driving transistor. However, there are variations in characteristics such as the threshold voltage and mobility of the driving transistors in different pixel circuits within the panel, which can result in different driving currents for different sub-pixels under the same data voltage signal, ultimately affecting the brightness uniformity of the panel. However, in traditional designs, the threshold voltage and the data voltage for controlling grayscale are written for a long time, or threshold voltage compensation and data voltage writing for controlling grayscale are performed simultaneously, resulting in high required light emitting brightness of the device or difficulty in ensuring sufficient compensation for the threshold voltage. Therefore, in order to ensure sufficient compensation for the threshold voltage and the ratio of the light emitting time to the frame time, it is necessary to reduce the light emitting brightness as much as possible and extend service life of the components.

Based on this, the embodiment of the present disclosure provides a pixel circuit, which includes a first energy storage circuit, a second energy storage circuit, a third energy storage circuit, a driving circuit, a data writing circuit, a transfer control circuit, and a first setting circuit. The data writing circuit, under a control of a writing control signal, writes a data voltage into the first energy storage circuit. Then charges are redistributed through the transfer control circuit, the second energy storage circuit, and the third energy storage circuit, so that the data voltage is written into a control terminal of the driving circuit, thereby increasing potential of the control terminal of the driving circuit. The pixel circuit described in the embodiment of the present disclosure can sufficiently compensate for the threshold voltage and can simultaneously write the data voltage during the light-emitting stage, increasing the light-emitting time and thus reducing the light-emitting brightness and increasing the service life.

Optionally, the DC voltage terminal can be a second voltage terminal, but is not limited to this.

In at least one embodiment of the present disclosure, the first voltage terminal may be a high voltage terminal, and the second voltage terminal may be a low voltage terminal.

Optionally, the setting voltage terminal can be an initial voltage terminal or the first voltage terminal, but is not limited to this.

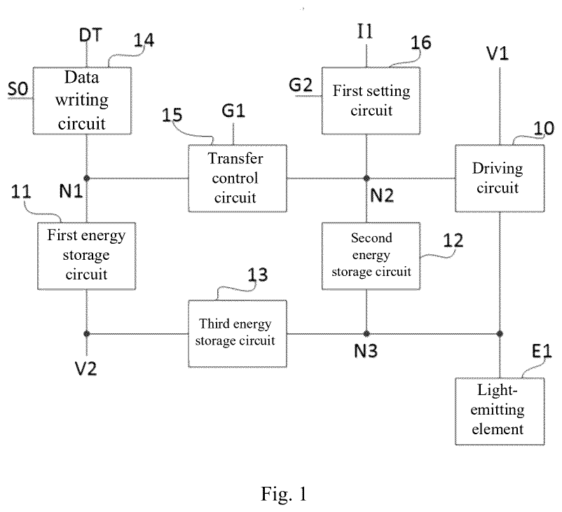

As shown in FIG. 1, the pixel circuit according to at least one embodiment of the present disclosure includes a light-emitting element E1, a first energy storage circuit 11, a second energy storage circuit 12, a third energy storage circuit 13, a driving circuit 10, a data writing circuit 14, a transfer control circuit 15, and a first setting circuit 16.

The first energy storage circuit 11 is electrically connected to a first node N1 and a second voltage terminal V2; The second energy storage circuit 12 is electrically connected to a second node N2 and a third node N3; The third energy storage circuit 13 is electrically connected to a second terminal of the first energy storage circuit 11 and the third node N3; The first energy storage circuit 11, the second energy storage circuit 12, and the third energy storage circuit 13 are configured to store electrical energy.

A control terminal of the driving circuit 10 is electrically connected to the second node N2. A first terminal of the driving circuit 10 is electrically connected to a first voltage terminal V1, and a second terminal of the driving circuit 10 is electrically connected to the light-emitting element E1 through the third node N3. The driving circuit 10 is configured to generate a driving current to drive the light-emitting element E1 under a control of potential of the second node N2.

The data writing circuit 14 is electrically connected to a writing control terminal S0, a data line DT, and the first node N1, and is configured to write a data voltage provided by the data line DT into the first node N1 under a control of a writing control signal provided by the writing control terminal S0.

The transfer control circuit 15 is electrically connected to a first scanning terminal G1, the first node N1, and the second node N2, and is configured to control the connection between the first node N1 and the second node N2 under a control of a first scanning signal provided by the first scanning terminal G1.

The first setting circuit 16 is electrically connected to a second scanning terminal G2, the second node N2, and an initial voltage terminal I1, and is configured to write an initial voltage Vi provided by the initial voltage terminal I1 into the second node N2 under a control of a second scanning signal provided by the second scanning terminal G2.

When the pixel circuit according to at least one embodiment shown in FIG. 1 of the present disclosure is in operation, a display period of the pixel circuit includes a compensation stage, a data transfer stage, and a light-emitting stage set sequentially. The light-emitting stage includes a data writing period;

In the compensation stage, the first setting circuit 16, under the control of the second scanning signal, writes the initial voltage Vi provided by the initial voltage terminal I1 into the second node N2. The first voltage signal provided by the first voltage terminal V1 charges each energy storage circuit through the driving circuit 10 to change the potential of the third node N3 until the driving circuit 10 is disconnected;

In the data transfer stage, the transfer control circuit 15 controls the connection between the first node N1 and the second node N2 under the control of the first scanning signal;

In the light-emitting stage, the driving circuit 10 drives the light-emitting element E1 to emit light;

During the data writing period, the data writing circuit 14 writes the data voltage provided by the data line DT to the first node N1 under the control of the writing control signal.

The pixel circuit described in at least one embodiment of the present disclosure further includes a first light emitting control circuit;

The first light emitting control circuit is electrically connected to a first light emitting control terminal, the third node, and a first electrode of the light-emitting element, and is configured to control the connection between the third node and the first electrode of the light-emitting element under a control of a first light emitting control signal provided by the first light emitting control terminal;

A second electrode of the light-emitting element is electrically connected to the second voltage terminal.

In specific implementation, the pixel circuit may further include a first light emitting control circuit. The first light emitting control circuit controls the connection between the third node and the first electrode of the light-emitting element under the control of the first light emitting control signal.

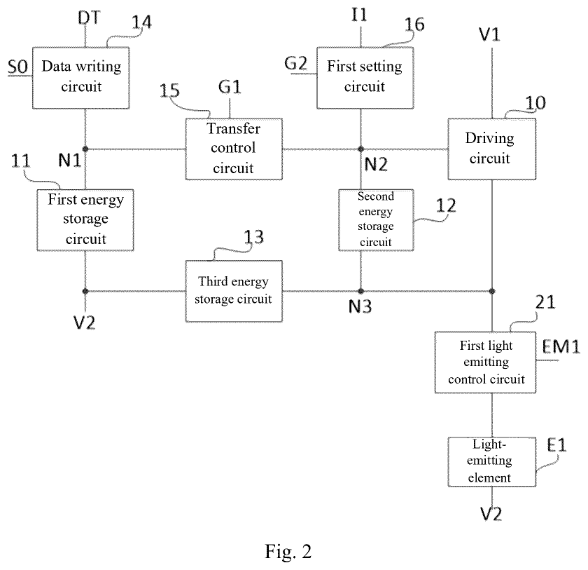

As shown in FIG. 2, based on at least one embodiment of the pixel circuit shown in FIG. 1, the pixel circuit described in at least one embodiment of the present disclosure further includes a first light emitting control circuit 21;

The first light emitting control circuit 21 is electrically connected to a first light emitting control terminal EM1, the third node N3, and a first electrode of the light-emitting element E1, and is configured to control a connection between the third node N3 and the first electrode of the light-emitting element E1 under a control of the first light emitting control signal provided by the first light emitting control terminal EM1;

A second electrode of the light-emitting element E1 is electrically connected to the second voltage terminal V2.

The pixel circuit described in at least one embodiment of the present disclosure further includes a second setting circuit;

The second setting circuit is electrically connected to a third scanning terminal and a third voltage terminal. The second setting circuit is further electrically connected to the second node or the third node. The second setting circuit is configured to write a third voltage signal provided by the third voltage terminal into the second node or the third node under a control of a third scanning signal provided by the third scanning terminal.

In specific implementation, the pixel circuit may further include a second setting circuit. The second setting circuit, under a control of a third scanning signal, writes a third voltage signal into the second node or the third node.

Optionally, the third voltage terminal can be a low voltage terminal, but is not limited to this.

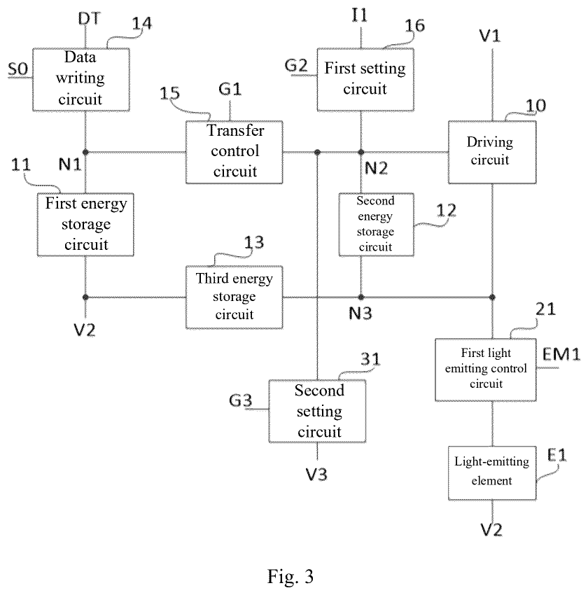

As shown in FIG. 3, based on at least one embodiment of the pixel circuit shown in FIG. 2, the pixel circuit described in at least one embodiment of the present disclosure further includes a second setting circuit 31;

The second setting circuit 31 is electrically connected to a third scanning terminal G3 and a third voltage terminal V3. The second setting circuit 31 is further electrically connected to the second node N2. The second setting circuit 31 is configured to write a third voltage signal provided by the third voltage terminal V3 into the second node N2 under a control of a third scanning signal provided by the third scanning terminal G3.

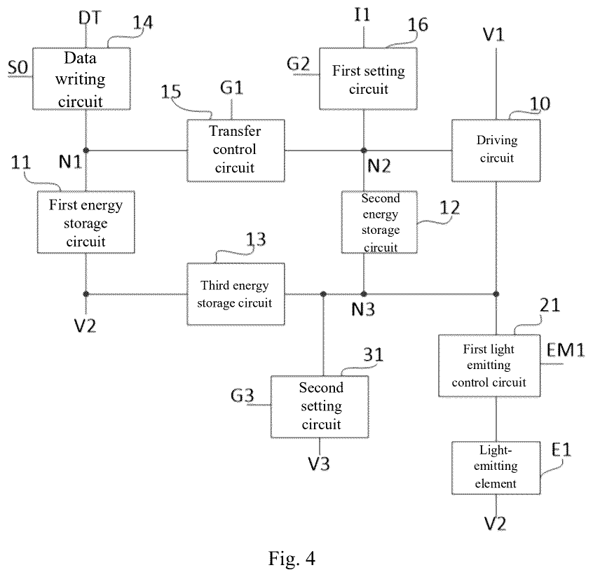

As shown in FIG. 4, based on at least one embodiment of the pixel circuit shown in FIG. 2, the pixel circuit described in at least one embodiment of the present disclosure further includes a second setting circuit 31;

The second setting circuit 31 is electrically connected to a third scanning terminal G3 and a third voltage terminal V3. The second setting circuit 31 is further electrically connected to the third node N3. The second setting circuit 31 is configured to write a third voltage signal provided by the third voltage terminal V3 into the third node N3 under a control of a third scanning signal provided by the third scanning terminal G3.

The pixel circuit described in at least one embodiment of the present disclosure further includes a second light emitting control circuit; The first terminal of the driving circuit is electrically connected to the first voltage terminal through the second light emitting control circuit

The second light emitting control circuit is electrically connected to a second light emitting control terminal, and is configured to control the connection between the first voltage terminal and the first terminal of the driving circuit under a control of a second light emitting control signal provided by the second light emitting control terminal.

In specific implementation, the pixel circuit may further include a second light emitting control circuit. The second light emitting control circuit controls the connection between the first voltage terminal and the first terminal of the driving circuit under a control of a second light emitting control signal.

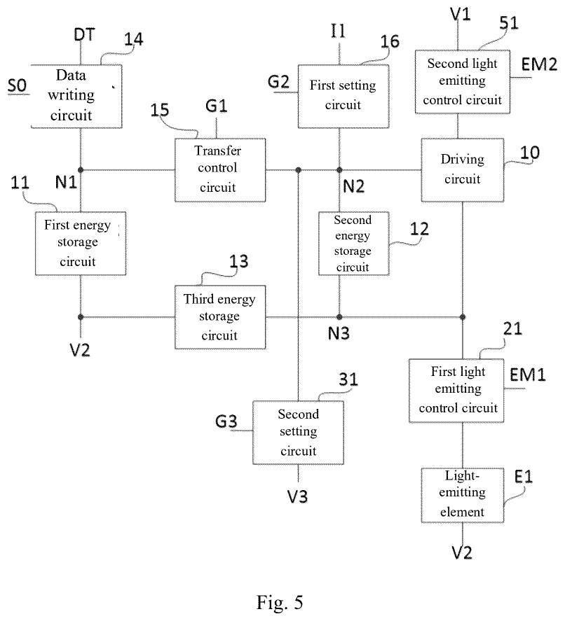

As shown in FIG. 5, based on at least one embodiment of the pixel circuit shown in FIG. 3, the pixel circuit described in at least one embodiment of the present disclosure further includes a second light emitting control circuit 51; The first terminal of the driving circuit 10 is electrically connected to the first voltage terminal V1 through the second light emitting control circuit 51;

The second light emitting control circuit 51 is electrically connected to a second light emission control terminal EM2, and is configured to control the connection between the first voltage terminal V1 and the first terminal of the driving circuit 10 under a control of a second light emitting control signal provided by the second light emitting control terminal EM2.

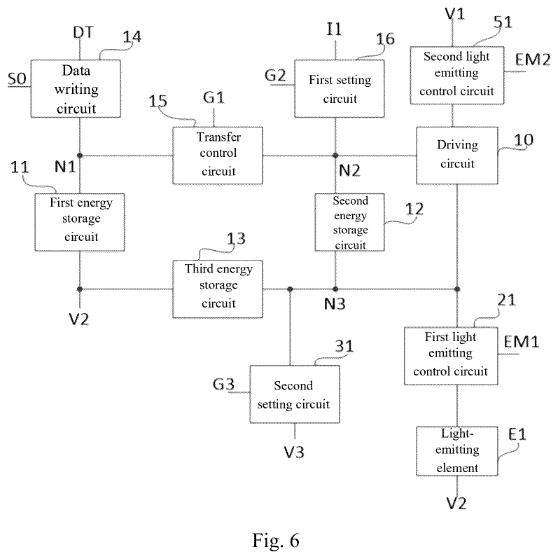

As shown in FIG. 6, based on at least one embodiment of the pixel circuit shown in FIG. 4, the pixel circuit described in at least one embodiment of the present disclosure further includes a second light emitting control circuit 51; The first terminal of the driving circuit 10 is electrically connected to the first voltage terminal V1 through the second light emitting control circuit 51;

The second light emitting control circuit 51 is electrically connected to a second light emitting control terminal EM2, and is configured to control the connection between the first voltage terminal V1 and the first terminal of the driving circuit 10 under a control of a second light emitting control signal provided by the second light emitting control terminal EM2.

In at least one embodiment of the present disclosure, the pixel circuit may be a glass based self light-emitting active pixel circuit.

Optionally, the first energy storage circuit includes a first capacitor, the second energy storage circuit includes a second capacitor, and the third energy storage circuit includes a third capacitor;

A first terminal of the first capacitor is electrically connected to the first node, and a second terminal of the first capacitor is electrically connected to the DC voltage terminal;

A first terminal of the second capacitor is electrically connected to the second node, and a second terminal of the second capacitor is electrically connected to the third node;

A first terminal of the third capacitor is electrically connected to the second terminal of the first capacitor, and a second terminal of the third capacitor is electrically connected to the third node.

Optionally, the data writing circuit includes a first transistor, and the transfer control circuit includes a second transistor;

A gate of the first transistor is electrically connected to the writing control terminal, a first electrode of the first transistor is electrically connected to the data line, and a second electrode of the first transistor is electrically connected to the first node;

A gate of the second transistor is electrically connected to the first scanning terminal, a first electrode of the second transistor is electrically connected to the first node, and the second electrode of the second transistor is electrically connected to the second node.

Optionally, the first setting circuit includes a third transistor;

A gate of the third transistor is electrically connected to the second scanning terminal, a first electrode of the third transistor is electrically connected to the setting voltage terminal, and the second electrode of the third transistor is electrically connected to the second node.

Optionally, the second setting circuit includes a fourth transistor;

A gate of the fourth transistor is electrically connected to the third scanning terminal, a first electrode of the fourth transistor is electrically connected to the third voltage terminal, and a second electrode of the fourth transistor is electrically connected to the second node or the third node.

Optionally, the driving circuit includes a driving transistor, the second light emitting control circuit includes a fifth transistor, and the first light emitting control circuit includes a sixth transistor;

A gate of the driving transistor is electrically connected to the second node, and a second electrode of the driving transistor is electrically connected to the third node;

A gate of the fifth transistor is electrically connected to the second light emitting control terminal, a first electrode of the fifth transistor is electrically connected to the first voltage terminal, and a second electrode of the fifth transistor is electrically connected to the first electrode of the driving transistor;

A gate of the sixth transistor is electrically connected to the first light emitting control terminal, a first electrode of the sixth transistor is electrically connected to the third node, and a second electrode of the sixth transistor is electrically connected to the first electrode of the light-emitting element.

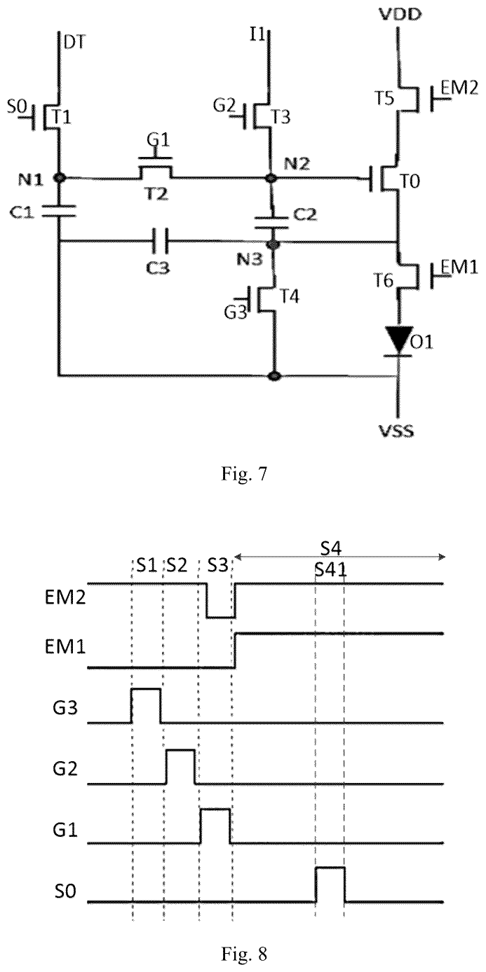

As shown in FIG. 7, based on at least one embodiment of the pixel circuit shown in FIG. 6, the first energy storage circuit includes a first capacitor C1, the second energy storage circuit includes a second capacitor C2, and the third energy storage circuit includes a third capacitor C3;

A first terminal of the first capacitor C1 is electrically connected to the first node N1, and a second terminal of the first capacitor C1 is electrically connected to a low voltage terminal VSS;

A first terminal of the second capacitor C2 is electrically connected to the second node N2, and a second terminal of the second capacitor C2 is electrically connected to the third node N3;

A first terminal of the third capacitor C3 is electrically connected to the second terminal of the first capacitor C1, and a second terminal of the third capacitor C3 is electrically connected to the third node N3;

The data writing circuit includes a first transistor T1, and the transfer control circuit includes a second transistor T2;

A gate of the first transistor T1 is electrically connected to the writing control terminal S0, a drain of the first transistor T1 is electrically connected to the data line DT, and a source of the first transistor T1 is electrically connected to the first node N1;

A gate of the second transistor T2 is electrically connected to the first scanning terminal G1, a drain of the second transistor T2 is electrically connected to the first node N1, and a source of the second transistor T2 is electrically connected to the second node N2;

The first setting circuit includes a third transistor T3;

A gate of the third transistor T3 is electrically connected to the second scanning terminal G2, a drain of the third transistor T3 is electrically connected to the initial voltage terminal I1, and a source of the third transistor T3 is electrically connected to the second node N2;

The second setting circuit includes a fourth transistor T4;

A gate of the fourth transistor T4 is electrically connected to the third scanning terminal G3, a drain of the fourth transistor T4 is electrically connected to the low voltage terminal VSS, and a source of the fourth transistor T4 is electrically connected to the third node N3;

The driving circuit includes a driving transistor TO, the second light emitting control circuit includes a fifth transistor T5, and the first light emitting control circuit includes a sixth transistor T6; The light-emitting element includes an organic light emitting diode O1;

A gate of the driving transistor TO is electrically connected to the second node N2, and a source of the driving transistor TO is electrically connected to the third node N3;

A gate of the fifth transistor T5 is electrically connected to the second light emitting control terminal EM2, a drain of the fifth transistor T5 is electrically connected to a high voltage terminal VDD, and a source of the fifth transistor T5 is electrically connected to a drain of the driving transistor TO;

A gate of the sixth transistor T6 is electrically connected to the first light emitting control terminal EM1, a drain of the sixth transistor T6 is electrically connected to the third node N3, and a source of the sixth transistor T6 is electrically connected to an anode of the organic light emitting diode O1;

A cathode of O1 is electrically connected to the low voltage terminal VSS.

In at least one embodiment of the pixel circuit shown in FIG. 7, all transistors are n-type transistors, but not limited to them.

As shown in FIG. 8, when the pixel circuit according to at least one embodiment shown in FIG. 7 of the present disclosure is in operation, a display period (which may be one frame time) may include an initialization stage S1, a compensation stage S2, a data transfer stage S3, and a light emitting stage S4 set sequentially, wherein the light emitting stage S4 includes a data writing period S41;

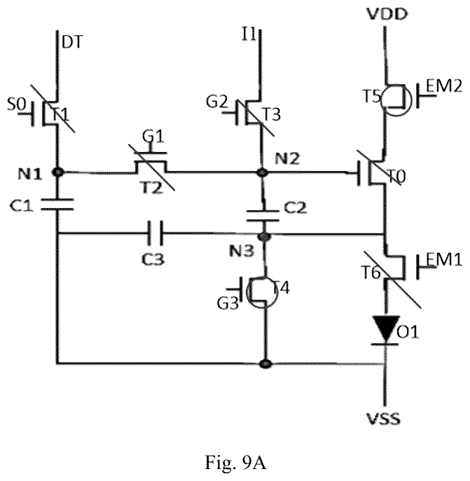

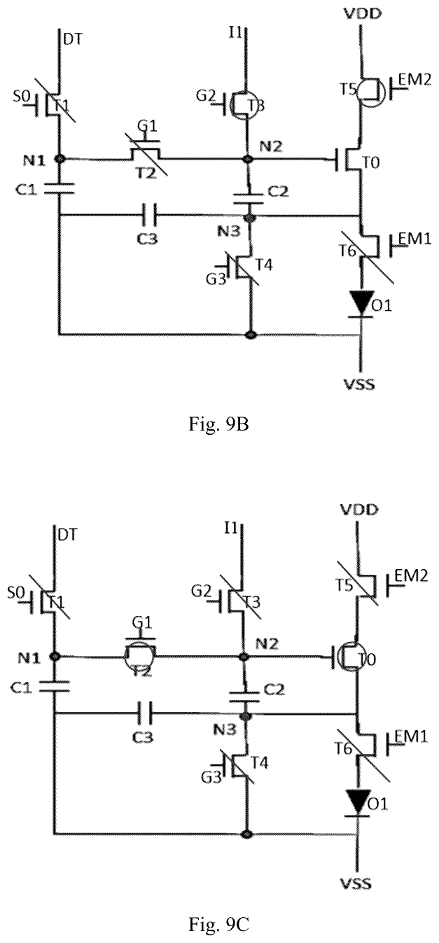

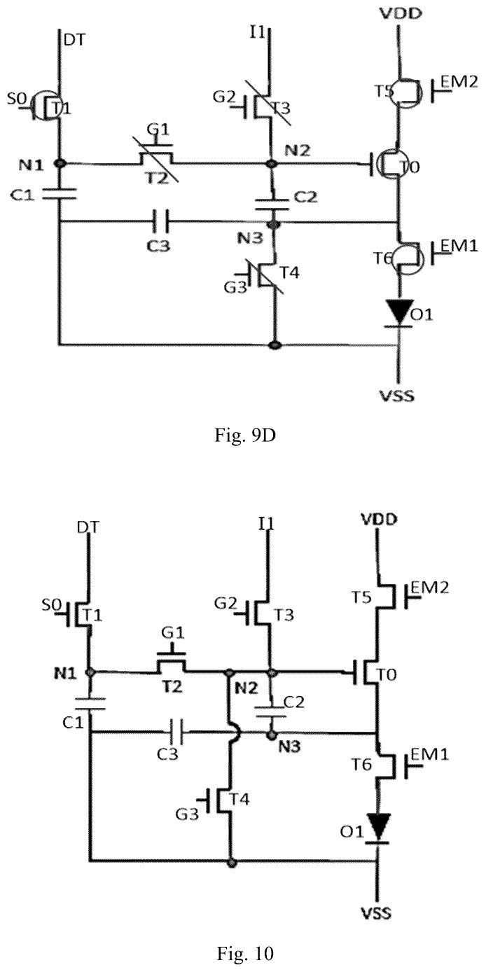

In the initialization stage S1, G3 provides a high voltage signal, and EM2 provides a high voltage signal, as shown in FIG. 9A. T5 is turned on, T4 is turned on, and N3 is connected to VSS. Due to a coupling effect of C2, a voltage jump of N2 is reset;

In the compensation stage S2, EM2 provides a high voltage signal, and G2 provides a high voltage signal, as shown in FIG. 9B. T3 and T5 are turned on, and the initial voltage Vi provided by I1 is written to the second node N2;

At a beginning of the compensation stage S2, TO is turned on, and the high voltage signal provided by VDD charges the capacitor through T5 and TO until the potential of N3 becomes Vi-Vth, and T0 is turned off; Vth is the threshold voltage of T0;

In the data transfer stage S3, G1 provides a high voltage signal, and EM2 provides a low voltage signal, as shown in FIG. 9C. T2 is turned on, TO is turned on, and the data voltage Vd written in the previous display period is transferred from N1 to N2, and charges are redistributed between C1, C2, and C3 through capacitor hopping. At the time, Vg=VN1=VN2=Vi+ΔV, Vs=VN3=Vi-Vth+ (Cz2/(Cz2+Cz3))×ΔV; Where, Vg is gate voltage of TO, Vs is source voltage of TO, VN1 is the potential of N1, VN2 is the potential of N2, VN3 is the potential of N3, C1z is a capacitance value of C1, Cz2 is a capacitance value of C2, Cz3 is a capacitance value of C3, and A Vis a voltage change value;

During the light emitting stage S4, EM1 and EM2 provide high voltage signals, T5 and T6 are turned on, and TO generates a driving current;

Where,

$$Δ V = ( 1 - \frac{Cz 2 \times Cz 3}{Cz 1 \times Cz 2 + Cz 1 \times Cz 3 + Cz 2 \times Cz 3} ) ( Vd - Vi ) ;$$

$$Vgs = Vg - Vs = \frac{Cz 1 \times Cz 3}{Cz 1 \times Cz 2 + Cz 1 \times Cz 3 + Cz 2 T 1 \times Cz 3} ( Vd - Vi ) + V th ,$$

Vth is a threshold voltage of the driving transistor, Vgs is a gate source voltage of TO;

$$I = K \times {( Vgs - Vth )}^{2} = K \times {A}^{2} * {( Vd - Vi )}^{2} ;$$

I is a current value of the driving current;

$$K = 1 / 2 \times μ \times Cox \times W / L ,$$

K is a current coefficient of T0, μ is an electron migration rate, Cox is a capacitance of a gate oxide layer per unit area, W/L is a width-to-length ratio of the driving transistor,

$$A = \frac{Cz 1 \times Cz3}{Cz 1 \times Cz 2 + Cz 1 \times Cz 3 + Cz 2 \times Cz 3} ;$$

During the data writing period S41, S0 provides a high voltage signal and T1 is turned on to write the data voltage of the next frame into the first node N1;

As shown in FIG. 9D, during the data writing period S41, T1 is turned on, and T5, T6, and TO are turned on.

As shown in FIG. 8, the light emitting stage S4 includes a data writing period S41; At the same time as TO drives O1 to emit light, during the data writing period S41, the data voltage of the next frame time is written to the first node N1, which increases the light emitting time, reduces the light emitting brightness, and increases the service life.

The difference between at least one embodiment of the pixel circuit shown in FIG. 10 of the present disclosure and at least one embodiment of the pixel circuit shown in FIG. 7 of the present disclosure is that the source of T4 is electrically connected to the second node N2.

As shown in FIG. 8, when the pixel circuit according to at least one embodiment shown in FIG. 10 of the present disclosure is in operation, the display period (which may be one frame time) may include an initialization stage S1, a compensation stage S2, a data transfer stage S3, and a light emitting stage S4 set sequentially. Wherein the light emitting stage S4 includes a data writing period S41;

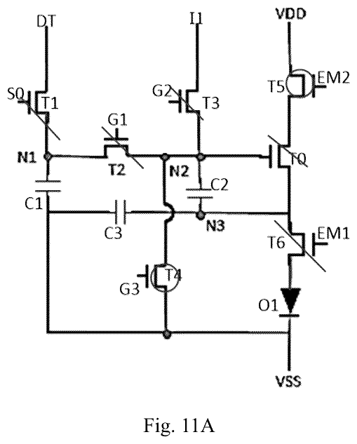

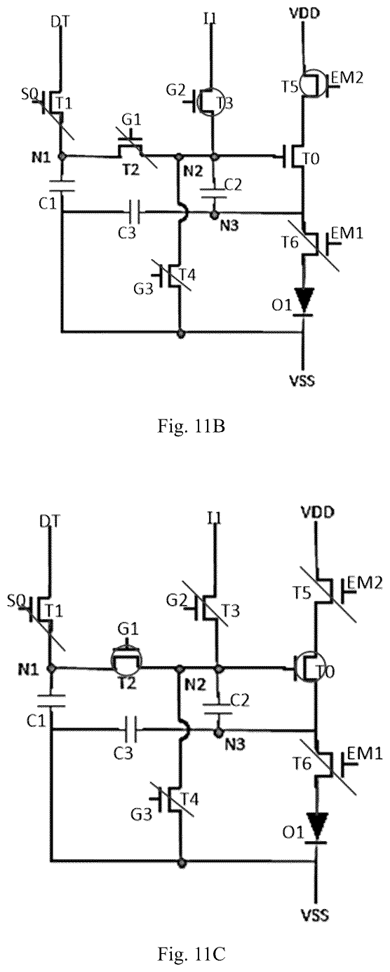

In the initialization stage S1, G3 provides a high voltage signal, and EM2 provides a high voltage signal, as shown in FIG. 11A. T5 is turned on, T4 is turned on, and N2 is connected to VSS to reset the potential of N2;

In the compensation stage S2, EM2 provides a high voltage signal, G2 provides a high voltage signal, as shown in FIG. 11B. T3 and T5 are turned on, and the initial voltage Vi provided by I1 is written to the second node N2;

At a beginning of the compensation stage S2, TO is turned on, and the high voltage signal provided by VDD charges the capacitor through T5 and TO until the potential of N3 becomes Vi-Vth, and T0 is turned off; Vth is the threshold voltage of T0;

In the data transfer stage S3, G1 provides a high voltage signal and EM2 provides a low voltage signal, as shown in FIG. 11C. T2 is turned on, TO is turned on, and the data voltage Vd written in the previous display period is transferred from N1 to N2, and charges are redistributed between C1, C2, and C3 through capacitor hopping. At the time, Vg=VN1=VN2=Vi+ΔV, Vs=VN3=Vi-Vth+ (Cz2/(Cz2+Cz3))×ΔV; Where, Vg is a gate voltage of T0, Vs is a source voltage of T0, VN1 is the potential of N1, VN2 is the potential of N2, VN3 is the potential of N3, C1z is a capacitance value of C1, Cz2 is a capacitance value of C2, Cz3 is a capacitance value of C3, and ΔV is a voltage change value;

In the light emitting stage S4, EM1 and EM2 provide high voltage signals, T5 and T6 are turned on, and T0 generates a driving current;

Where,

$$Δ V = ( 1 - \frac{Cz 2 \times Cz 3}{Cz 1 \times Cz 2 + Cz 1 \times Cz 3 + Cz 2 \times Cz 3} ) ( Vd - Vi ) ;$$

$$Vgs = Vg - Vs = \frac{Cz 1 \times Cz 3}{Cz 1 \times Cz 2 + Cz 1 \times Cz 3 + Cz 2 T 1 \times Cz 3} ( Vd - Vi ) + V th ,$$

Vth is the threshold voltage of DTFT, Vgs is a gate source voltage of T0;

$$I = K \times {( Vgs - Vth )}^{2} = K \times {A}^{2} * {( Vd - Vi )}^{2} ;$$

I is a current value of the driving current;

$$K = 1 / 2 \times μ \times Cox \times W / L ,$$

K is a current coefficient of T0, μ is an electron migration rate, Cox is a capacitance of a gate oxide layer per unit area, W/L is a width-to-length ratio of

$$DTFT , A = \frac{Cz 1 \times Cz 3}{Cz 1 \times Cz 2 + Cz 1 \times Cz 3 + Cz 2 \times Cz 3} ;$$

During the data writing period S41, S0 provides a high voltage signal and T1 is turned on to write the data voltage of the next frame into the first node N1;

As shown in FIG. 11D, during the data writing period S41, T1 is turned on, and T5, T6, and T0 are turned on.

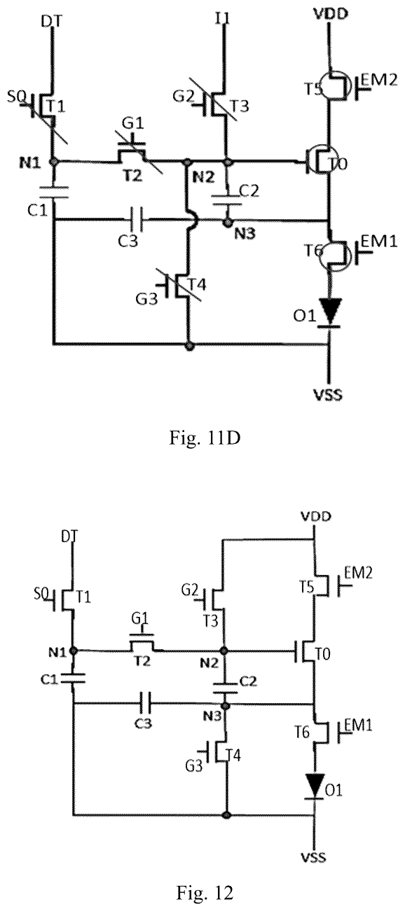

The difference between at least one embodiment of the pixel circuit shown in FIG. 12 of the present disclosure and at least one embodiment of the pixel circuit shown in FIG. 7 of the present disclosure is that the drain of T3 is electrically connected to the high voltage terminal VDD.

As shown in FIG. 8, when the pixel circuit according to at least one embodiment shown in FIG. 12 of the present disclosure is in operation, the display period (which may be one frame time) may include an initialization stage S1, a compensation stage S2, a data transfer stage S3, and a light emitting stage S4 set sequentially. Where the light emitting stage S4 includes a data writing period S41;

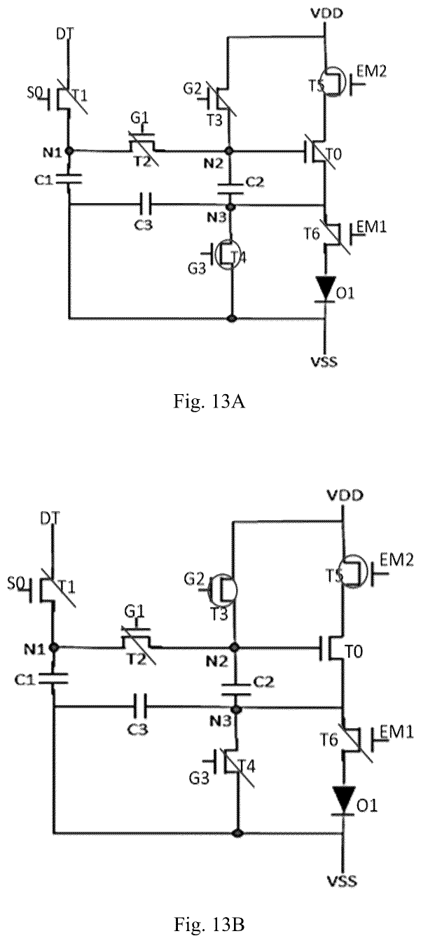

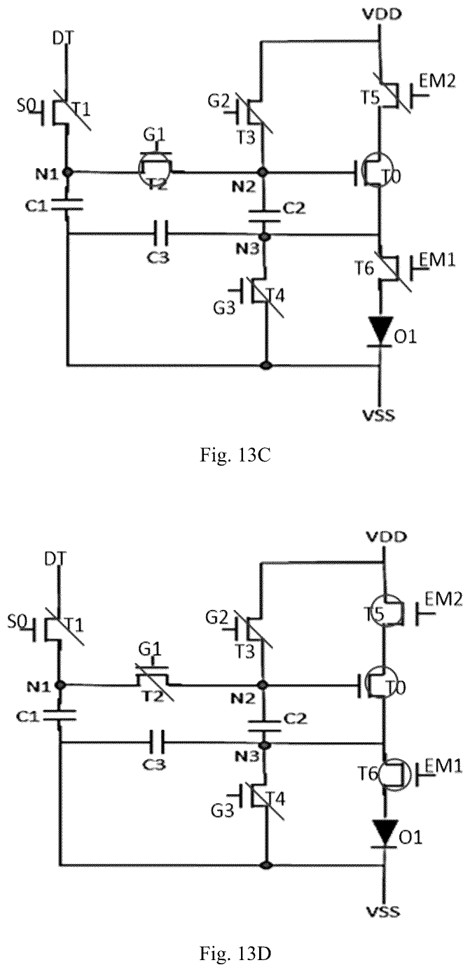

In the initialization stage S1, G3 provides a high voltage signal, and EM2 provides a high voltage signal, as shown in FIG. 13A. T5 is turned on, T4 is turned on, and N2 is connected to VSS to reset the potential of N2;

In the compensation stage S2, EM2 provides a high voltage signal, and G2 provides a high voltage signal, as shown in FIG. 13b. T3 and T5 are turned on, and the high voltage signal provided by VDD is written to the second node N2;

At a beginning of the compensation stage S2, T0 is turned on, and the high voltage signal provided by VDD charges the capacitor through T5 and T0 until the potential of N3 becomes VDD-Vth, and T0 is turned off; Vth is the threshold voltage of T0, and Vdd is the voltage value of the high voltage signal;

In the data transfer stage S3, G1 provides a high voltage signal and EM2 provides a low voltage signal, as shown in FIG. 13C. T2 is turned on, T0 is turned on, and the data voltage Vd written in the previous display period is transferred from N1 to N2, and charges are redistributed between C1, C2, and C3 through capacitor hopping. At the time, Vg=VN1=VN2=Vdd+ΔV, Vs=VN3=Vdd−Vth+(Cz2/(Cz2+Cz3))×ΔV; Where, Vg is a gate voltage of T0, Vs is a source voltage of T0, VN1 is the potential of N1, VN2 is the potential of N2, VN3 is the potential of N3, Clz is a capacitance value of C1, Cz2 is a capacitance value of C2, Cz3 is a capacitance value of C3, and ΔV is a voltage change value;

In the light emitting stage S4, EM1 and EM2 provide high voltage signals, T5 and T6 are turned on, and T0 generates a driving current;

Where,

$$Δ V = ( 1 - \frac{Cz 2 \times Cz 3}{Cz 1 \times Cz 2 + Cz 1 \times Cz 3 + Cz 2 \times Cz 3} ) ( Vd - Vdd ) ;$$

$$Vgs = Vg - Vs = \frac{Cz 1 \times Cz 3}{Cz 1 \times Cz 2 + Cz 1 \times Cz 3 + Cz 2 T 1 \times Cz 3} ( Vd - Vdd ) + V th ,$$

Vth is the threshold voltage of DTFT, Vgs is a gate source voltage of T0;

$$I = K \times ( Vgs - Vth ) 2 = K \times A 2 * {( Vd - Vdd )}^{2} ;$$

I is a current value of the driving current; K=1/2×μ×Cox×W/L, K is a current coefficient of T0, μ is an electron migration rate, Cox is a capacitance of a gate oxide layer per unit area, W/L is a width-to-length ratio of DTFT,

$$A = \frac{Cz 1 \times Cz 3}{Cz 1 \times Cz 2 + Cz 1 \times Cz 3 + Cz 2 \times Cz 3} ;$$

During the data writing period S41, S0 provides a high voltage signal and T1 is turned on to write the data voltage of the next frame into the first node N1;

As shown in FIG. 13D, during the data writing period S41, T1 is turned on, and T5, T6, and T0 are turned on.

In at least one embodiment of the present disclosure, the light-emitting element may be an LED (light emitting diode), mini LED (mini light emitting diode), micro LED (micro light emitting diode), or OLED (organic light emitting diode), but not limited to these.

The driving method according to the embodiment of the present disclosure is applied to the pixel circuit mentioned above. The display period of the pixel circuit includes a compensation stage, a data transfer stage, and a light emitting stage set sequentially. The light emitting stage includes a data writing period; The driving method includes:
In the compensation stage, the first setting circuit writes the setting voltage provided by the setting voltage terminal to the second node under the control of the second scanning signal. The first voltage signal provided by the first voltage terminal charges each energy storage circuit through the driving circuit to change the potential of the third node until the driving circuit is disconnected;
In the data transfer stage, the transfer control circuit controls the connection between the first node and the second node under the control of the first scanning signal;
In the light emitting stage, the driving circuit drives the light-emitting element to emit light;
During the data writing period, the data writing circuit writes the data voltage provided by the data line to the first node under the control of the writing control signal.

In at least one embodiment of the present disclosure, the pixel circuit further includes a first light emitting control circuit; The driving method further includes:

In the light emitting stage, the first light emitting control circuit controls the connection between the third node and the first electrode of the light-emitting element under the control of the first light emitting control signal.

In at least one embodiment of the present disclosure, the pixel circuit further includes a second setting circuit; The display period further includes an initialization stage set before the compensation stage; The driving method further includes:

In the initialization stage, the second setting circuit writes the third voltage signal into the second node or the third node under the control of the third scanning signal.

In at least one embodiment of the present disclosure, the pixel circuit further includes a second light emitting control circuit; The driving method further includes:

In the compensation stage and the light emitting stage, the second light emitting control circuit controls the connection between the first voltage terminal and the first terminal of the driving circuit under the control of the second light emitting control signal.

The display device according to the embodiment of the present disclosure includes the pixel circuit mentioned above.

In at least one embodiment of the present disclosure, the display device may be an AM (Active Martrix, active martrix) display device, but is not limited to this.

The above are merely the preferred embodiments of the present disclosure. It should be noted that, a person skilled in the art may make further improvements and modifications without departing from the principle of the present disclosure, and these improvements and modifications shall also fall within the scope of the present disclosure.

1. A pixel circuit, comprising a light-emitting element, a first energy storage circuit, a second energy storage circuit, a third energy storage circuit, a driving circuit, a data writing circuit, a transfer control circuit, and a first setting circuit;
the first energy storage circuit is electrically connected to a first node and a DC voltage terminal; the second energy storage circuit is electrically connected to a second node and a third node; the third energy storage circuit is electrically connected to a second terminal of the first energy storage circuit and the third node; the first energy storage circuit, the second energy storage circuit, and the third energy storage circuit are configured to store electrical energy;
a control terminal of the driving circuit is electrically connected to the second node, a first terminal of the driving circuit is electrically connected to the first voltage terminal, and a second terminal of the driving circuit is electrically connected to the light-emitting element through the third node, the driving circuit is configured to generate a driving current to drive the light-emitting element under a control of potential of the second node;
the data writing circuit is electrically connected to a writing control terminal, a data line, and the first node, and is configured to write a data voltage provided by the data line to the first node under a control of a writing control signal provided by the writing control terminal;
the transfer control circuit is electrically connected to a first scanning terminal, the first node, and the second node, and is configured to control the connection between the first node and the second node under a control of a first scanning signal provided by the first scanning terminal;
the first setting circuit is electrically connected to a second scanning terminal, the second node, and a setting voltage terminal, and is configured to write a setting voltage provided by the setting voltage terminal to the second node under a control of a second scanning signal provided by the second scanning terminal.

2. The pixel circuit according to claim 1, further comprising a first light emitting control circuit;
the first light emitting control circuit is electrically connected to a first light emitting control terminal, the third node, and a first electrode of the light-emitting element, and is configured to control the connection between the third node and the first electrode of the light-emitting element under a control of a first light emitting control signal provided by the first light emitting control terminal;
a second electrode of the light-emitting element is electrically connected to the second voltage terminal.

3. The pixel circuit according to claim 1, further comprising a second setting circuit;
the second setting circuit is electrically connected to a third scanning terminal and a third voltage terminal, the second setting circuit is further electrically connected to the second node or the third node, the second setting circuit is configured to write a third voltage signal provided by the third voltage terminal into the second node or the third node under a control of a third scanning signal provided by the third scanning terminal.

4. The pixel circuit according to claim 2, further comprising a second light emitting control circuit; the first terminal of the driving circuit is electrically connected to the first voltage terminal through the second light emitting control circuit;
the second light emitting control circuit is electrically connected to a second light emitting control terminal, and is configured to control the connection between the first voltage terminal and the first terminal of the driving circuit under a control of a second light emitting control signal provided by the second light emitting control terminal.

5. The pixel circuit according to claim 1, wherein the first energy storage circuit comprises a first capacitor, the second energy storage circuit comprises a second capacitor, and the third energy storage circuit comprises a third capacitor;
a first terminal of the first capacitor is electrically connected to the first node, and a second terminal of the first capacitor is electrically connected to the DC voltage terminal;
a first terminal of the second capacitor is electrically connected to the second node, and a second terminal of the second capacitor is electrically connected to the third node;
a first terminal of the third capacitor is electrically connected to the second terminal of the first capacitor, and a second terminal of the third capacitor is electrically connected to the third node.

6. The pixel circuit according to claim 1, wherein the data writing circuit comprises a first transistor, and the transfer control circuit comprises a second transistor;
a gate of the first transistor is electrically connected to the writing control terminal, a first electrode of the first transistor is electrically connected to the data line, and a second electrode of the first transistor is electrically connected to the first node;
a gate of the second transistor is electrically connected to the first scanning terminal, a first electrode of the second transistor is electrically connected to the first node, and a second electrode of the second transistor is electrically connected to the second node.

7. The pixel circuit according to claim 1, wherein the first setting circuit comprises a third transistor;
a gate of the third transistor is electrically connected to the second scanning terminal, a first electrode of the third transistor is electrically connected to the setting voltage terminal, and a second electrode of the third transistor is electrically connected to the second node.

8. The pixel circuit according to claim 3, wherein the second setting circuit comprises a fourth transistor;
a gate of the fourth transistor is electrically connected to the third scanning terminal, a first electrode of the fourth transistor is electrically connected to the third voltage terminal, and a second electrode of the fourth transistor is electrically connected to the second node or the third node.

9. The pixel circuit according to claim 4, wherein the driving circuit comprises a driving transistor, the second light emitting control circuit comprises a fifth transistor, and the first light emitting control circuit comprises a sixth transistor;
a gate of the driving transistor is electrically connected to the second node, and a second electrode of the driving transistor is electrically connected to the third node;
a gate of the fifth transistor is electrically connected to the second light emitting control terminal, a first electrode of the fifth transistor is electrically connected to the first voltage terminal, and a second electrode of the fifth transistor is electrically connected to the first electrode of the driving transistor;
a gate of the sixth transistor is electrically connected to the first light emitting control terminal, a first electrode of the sixth transistor is electrically connected to the third node, and a second electrode of the sixth transistor is electrically connected to the first electrode of the light-emitting element.

10. A driving method, applied to the pixel circuit according to claim 1, wherein a display period of the pixel circuit comprises a compensation stage, a data transfer stage, and a light emitting stage set sequentially, the light emitting stage comprises a data writing period; the driving method comprises:
in the compensation stage, the first setting circuit writes the setting voltage provided by the setting voltage terminal to the second node under the control of the second scanning signal, the first voltage signal provided by the first voltage terminal charges each energy storage circuit through the driving circuit to change the potential of the third node until the driving circuit is disconnected;
in the data transfer stage, the transfer control circuit controls the connection between the first node and the second node under the control of the first scanning signal;
in the light emitting stage, the driving circuit drives the light-emitting element to emit light;
during the data writing period, the data writing circuit writes the data voltage provided by the data line to the first node under the control of the writing control signal.

11. The driving method according to claim 10, wherein the pixel circuit further comprises a first light emitting control circuit; the driving method further comprises:
in the light emitting stage, the first light emitting control circuit controls the connection between the third node and the first electrode of the light-emitting element under the control of the first light emitting control signal.

12. The driving method according to claim 10, wherein the pixel circuit further comprises a second setting circuit; the display period further comprises an initialization stage set before the compensation stage; the driving method further comprises:
in the initialization stage, the second setting circuit writes the third voltage signal into the second node or the third node under the control of the third scanning signal.

13. The driving method according to claim 10, wherein the pixel circuit further comprises a second light emitting control circuit; the driving method further comprises:
in the compensation stage and the light emitting stage, the second light emitting control circuit controls the connection between the first voltage terminal and the first terminal of the driving circuit under the control of the second light emitting control signal.

14. A display device, comprising the pixel circuit according to claim 1.
